(19) United States
(12) Patent Application Publication
(10) Pub. No.: US 2025/0042255 A1
(43) Pub. Date: Feb. 6, 2025

(54) DEVICE AND METHOD FOR OPERATING AN ELECTRIC AUXILIARY DRIVE FOR AN ELECTRIC VEHICLE, ELECTRIC VEHICLE, ELECTRIC AUXILIARY DRIVE FOR AN ELECTRIC VEHICLE, AND METHOD FOR PROVIDING REFERENCE DATASETS FOR A DEVICE FOR OPERATING AN ELECTRIC AUXILIARY DRIVE FOR AN ELECTRIC VEHICLE

(71) Applicant: ZF FRIEDRICHSHAFEN AG, Friedrichshafen (DE)

(72) Inventors: Vladimir DVORAK, Schwandorf (DE); Martin MACH, Preštice (CZ); Zbynek ŠTEPÁN, Starý Plzenec (CZ); Frank SEEMANN, Euerbach (DE); Andre EHRSAM, Bergrheinfeld (DE); Gabriel SCHERER, Deggenhausertal (DE); Tato Gervais AMANI, Nürnberg (DE); Matthias ENGICHT, Bodman-Ludwigshafen (DE)

(21) Appl. No.: 18/718,898

(22) PCT Filed: Dec. 14, 2022
(86) PCT No.: PCT/EP2022/085940

§ 371 Date: Jun. 12, 2024

(30) Foreign Application Priority Data
Dec. 15, 2021 (DE) 10 2021 214 413.6

(51) Int. Cl. B60L 1/00; B60L 15/00

(52) U.S. Cl. CPC B60L 1/003; B60L 15/007

(57) ABSTRACT

A device for operating an electric auxiliary drive for an electric vehicle has a bidirectional inverter having a battery interface for electrically connecting to a vehicle battery and an auxiliary drive interface for electrically connecting to the auxiliary drive; a control arrangement having a first communications interface for connecting to the electric vehicle and a second communications interface for connecting to the auxiliary drive. The control arrangement inputs a configuration signal representing a present configuration of the electric vehicle and/or of the auxiliary drive via one of the communications interfaces. The control arrangement is formed to use the configuration signal to determine control parameters from a plurality of reference datasets with control parameters for different electric vehicles and different auxiliary drives, which control parameters are associated with respective configurations, and to control the inverter using the control parameters.

### CROSS REFERENCE TO RELATED APPLICATIONS

This is a U.S. national stage of Application No. PCT/EP2022/085940 filed Dec. 14, 2022. Priority is claimed on German Application No. DE 10 2021 214 413.6 filed Dec. 15, 2021, the content of which is incorporated herein by reference.

### BACKGROUND OF THE INVENTION

### 1. Field of the Invention

The present disclosure is directed to a device for operating an electric auxiliary drive for an electric vehicle, an electric vehicle, an electric auxiliary drive for an electric vehicle, a method for the operation of an electric auxiliary drive for an electric vehicle, and a method for providing reference datasets for a device for operating an electric auxiliary drive for an electric vehicle, and a corresponding computer program.

### 2. Description of the Related Art

Immediate usability, also known as plug and play, can be utilized in many applications. Plug and play or immediate usability is a function which allows recognition of connected hardware and a simplified configuration and parameterization of software. Accordingly, the hardware used in the system can be discovered and, consequently, corresponding programs and functions can be started or activated automatically. To start with, a programming and preparation of the software can be carried out for this purpose. Every time a connection is made subsequently, detection of an actually connected system or of the actually connected hardware and an activation of relevant software functions can be carried out.

### SUMMARY OF THE INVENTION

With this in mind, one aspect of the present invention provides an improved device for operating an electric auxiliary drive for an electric vehicle, an improved electric vehicle, an improved electric auxiliary drive for an electric vehicle, an improved method for the operation of an electric auxiliary drive for an electric vehicle, an improved method for providing reference datasets for a device for operating an electric auxiliary drive for an electric vehicle, and an improved computer program in accordance with the main claims. Advantageous configurations will be apparent from the subclaims and the following description.

According to one aspect, in particular, an immediate usability, also known as plug-and-play functionality or PnP functionality, can be provided for an auxiliary drive installation of an electric vehicle. For example, this makes possible an electric auxiliary drive (ePTO=electric power takeoff) with immediate usability. The ePTO solution with PnP functionality described herein can be utilized, for example, for any vehicle or any application contained in a software database of a device for operating the electric auxiliary drive for the electric vehicle. In particular, software of a device of this kind can be adapted beforehand to a wide variety of applications and vehicles.

According to one aspect, in particular, an immediate usability can also advantageously be provided for an electric auxiliary drive installation. For example, costs and time can be economized with respect to a configuration of every vehicle, since preparation of the software and configuration can be carried out already beforehand. After connecting to the system, a further or additional configuration may be dispensed with. A standardized communication and interface can likewise be provided so that adaptation to a specific vehicle is unnecessary. Accordingly, flexibility can also be increased with respect to possible uses. In particular, it is possible in this way to provide an electric auxiliary drive which can be compatible with a plurality of vehicles or a plurality of accessory applications with respect to immediate operability.

A device for operating an electric auxiliary drive for an electric vehicle has the following features: a bidirectional inverter having a battery interface for electrically connecting the inverter to a vehicle battery of the electric vehicle and an auxiliary drive interface for electrically connecting the inverter to the auxiliary drive; and a control arrangement having a first communications interface for the signal-transmissible connection of the control arrangement to the electric vehicle and a second communications interface for the signal-transmissible connection of the control arrangement to the auxiliary drive, this control arrangement being formed to input a configuration signal provided in response to an information request via the first communications interface and, additionally or alternatively, via the second communications interface, the configuration signal representing a present configuration of the electric vehicle and, additionally or alternatively, of the auxiliary drive, the control arrangement being formed to use the configuration signal to determine a set of control parameters for the present configuration from a plurality of stored reference datasets with control parameters for different electric vehicles and different auxiliary drives, which control parameters are associated with respective configurations, the control arrangement being formed to control the inverter using the set of control parameters.

An electric vehicle can be a battery-operated vehicle, a hybrid vehicle, a vehicle using an internal combustion engine for driving the wheels and a battery as power supply for the auxiliary drive, a vehicle using an alternative propulsion, i.e., hydrogen, gas, etc., for driving the wheels and a battery as power supply for the auxiliary drive, or a vehicle using any combination of the above-mentioned types of power supplies for driving the wheels and for the auxiliary drive. The auxiliary drive can also be referred to as an accessory drive or a power takeoff unit. In addition to the auxiliary drive that can be provided for the electric vehicle, the electric vehicle can have a main drive or also a traction drive. An auxiliary drive can have a drive which is provided in addition to the main drive and which can be utilized as a power supply for additional applications. An additional application or accessory application can utilize the auxiliary drive. The auxiliary drive makes it possible to take off power from a source such as the vehicle battery and transmit the power to a consumer such as an accessory application. An electric auxiliary drive can be formed to take off electrical power from the vehicle battery and convert it in accordance with required parameters or control parameters for an accessory application. An “accessory application” may be understood to mean an implemented or separate machine used for work. Examples of vehicles with accessory applications include a transport refrigeration vehicle (cooling elements with refrigeration unit), a vehicle with hydraulic crane, a garbage truck, a municipal vehicle, a dump truck, etc. The inverter and the control arrangement can be connected to one another electrically and/or signal-transmissibly. A configuration can be based on hardware and/or software.

According to one aspect, the control arrangement can be formed to control the auxiliary drive using the set of control parameters via the second communications interface. An aspect of this kind offers the advantage that it makes possible a reliable and precise operation of the auxiliary drive with immediate usability.

The control arrangement can also be formed to detect a connection event using the interfaces of the device. The connection event can represent a reconnection or first-time connection of an electric auxiliary drive or of an electric vehicle to the device. The control arrangement can optionally additionally be formed to output the information request for providing the configuration signal in response to a detected connection event via the first communications interface and, additionally or alternatively, via the second communications interface. A form of this kind offers the advantage that it can enable a reliable operation with immediate usability in response to a coupling of the device with an electric vehicle and/or an auxiliary drive of any stored type.

There is also provided an electric vehicle which has a vehicle battery and a device mentioned herein. The inverter of the device is electrically connected to the vehicle battery via the battery interface and electrically connectable or electrically connected to the auxiliary drive via the auxiliary drive interface. Further, the control arrangement of the device is connected to the electric vehicle via the first communications interface so as to enable signal transmission and is connectable or connected to the auxiliary drive via the second communications interface so as to enable signal transmission.

The device can be arranged on the vehicle side. The vehicle can be utilized not only for merely one application but for many different accessory applications.

Further, an auxiliary drive for an electric vehicle has a device mentioned herein. The inverter of the device can be electrically connectable or electrically connected to the vehicle battery via the battery interface and electrically connected to the auxiliary drive via the auxiliary drive interface. The control arrangement of the device can be connectable or connected to the electric vehicle via the first communications interface so as to enable signal transmission and can be connected to the auxiliary drive via the second communications interface so as to enable signal transmission.

The auxiliary drive can have an electric motor and optionally additionally a pump. Accordingly, the device is arranged on the auxiliary drive side or on the attachment side or in attachments. Attachment suppliers can decide which vehicle they would like to use independent of an ePTO change.

Further, a method is presented for operating an electric auxiliary drive for an electric vehicle, the method having the following steps: inputting a configuration signal provided in response to an information request via a first communications interface to the electric vehicle and/or via a second communications interface to the auxiliary drive, which configuration signal represents a present configuration of the electric vehicle and/or of the auxiliary drive; determining with the use of the configuration signal a set of control parameters for the present configuration from a plurality of stored reference datasets with control parameters for different electric vehicles and different auxiliary drives, which control parameters are associated with respective configurations; and controlling a bidirectional inverter using the set of control parameters, the inverter having a battery interface for electrically connecting the inverter to a vehicle battery of the electric vehicle and an auxiliary drive interface for electrically connecting the inverter to the auxiliary drive.

The method for operation can be carried out by the device mentioned herein, particularly the control arrangement of the device. The control arrangement of the device is accordingly adapted to carry out and/or initiate the steps of the method presented herein in corresponding units. A control arrangement can be an electric device which processes electrical signals, for example, sensor signals, and outputs control signals depending on the latter. The control arrangement can have one or more suitable interfaces which can be formed as hardware and/or software. In case of a hardware configuration, the interfaces can be part of an integrated circuit, for example, in which functions of the device are implemented. The interfaces can also comprise independent integrated circuits or can at least in part comprise discrete components. In case of a software configuration, the interfaces can be software modules which are provided, for example, on a microcontroller in addition to other software modules.

According to an aspect, the auxiliary drive can be controlled in the control step using the set of control parameters via the second communications interface. Such an aspect offers the advantage that it makes possible a reliable and precise operation of the auxiliary drive with immediate usability.

The method can also have a step of detecting a connection event using the interfaces of the device. The connection event can represent a reconnection or first-time connection of an electric auxiliary drive or of an electric vehicle to the device. The method can optionally additionally have an output step for outputting the information request for providing the configuration signal via the first communications interface and, additionally or alternatively, via the second communications interface in response to a detected connection event. Such an aspect offers the advantage that it can make possible a reliable operation with immediate usability in response to a coupling of the device with an electric vehicle and/or with an auxiliary drive of any stored type.

The input step and the determination step can be carried out once after every detected connection event. Such an embodiment form offers the advantage that the immediate usability can be realized in a simple and reliable manner.

Further, a method is presented for providing reference datasets for a device for operating an electric auxiliary drive for an electric vehicle, which method has the following steps: inputting configuration information representing different configurations and control parameters for different electric vehicles and different auxiliary drives, which control parameters are associated with the respective configurations; and storing the configuration information and control parameters in order to generate a plurality of reference datasets with control parameters associated with the respective configurations.

By carrying out the method for providing, reference datasets can also be provided for use by an embodiment form of the method for operating mentioned herein. In other words, when the method for operating is carried out, the reference datasets provided according to the method for providing can be accessed.

Further, a computer program is presented which is adapted to carry out and/or initiate the steps of an embodiment form of a method presented herein.

A computer program product with program code which can be stored on a machine-readable storage medium such as a semiconductor storage, a hard disk storage or an optical storage is also advantageous and is used for carrying out a method according to one of the embodiment forms described herein when the program is executed on a computer, a control arrangement or a device.

### BRIEF DESCRIPTION OF THE DRAWINGS

The invention will be explained in more detail by way of example with reference to the accompanying drawings. The drawings show:

FIG. 1 is a schematic depiction of an embodiment example of a device for operating an electric auxiliary drive for an electric vehicle;

FIG. 2 is a flow diagram of an embodiment example of a method for operating an electric auxiliary drive for an electric vehicle;

FIG. 3 is a flow diagram of an embodiment example of a method for providing reference datasets for a device for operating an electric auxiliary drive for an electric vehicle;

FIG. 4 is a schematic depiction of an embodiment example of a device for operating an electric auxiliary drive for an electric vehicle; and

FIG. 5 is a schematic depiction of a function principle of the device from FIG. 1 and/or FIG. 4 with respect to a system configuration.

### DETAILED DESCRIPTION OF THE PRESENTLY PREFERRED EMBODIMENTS

In the following description of preferred embodiment examples of the present invention, like or similar reference numerals are used for the similarly operating elements shown in the various figures to avoid repetitive description of these elements.

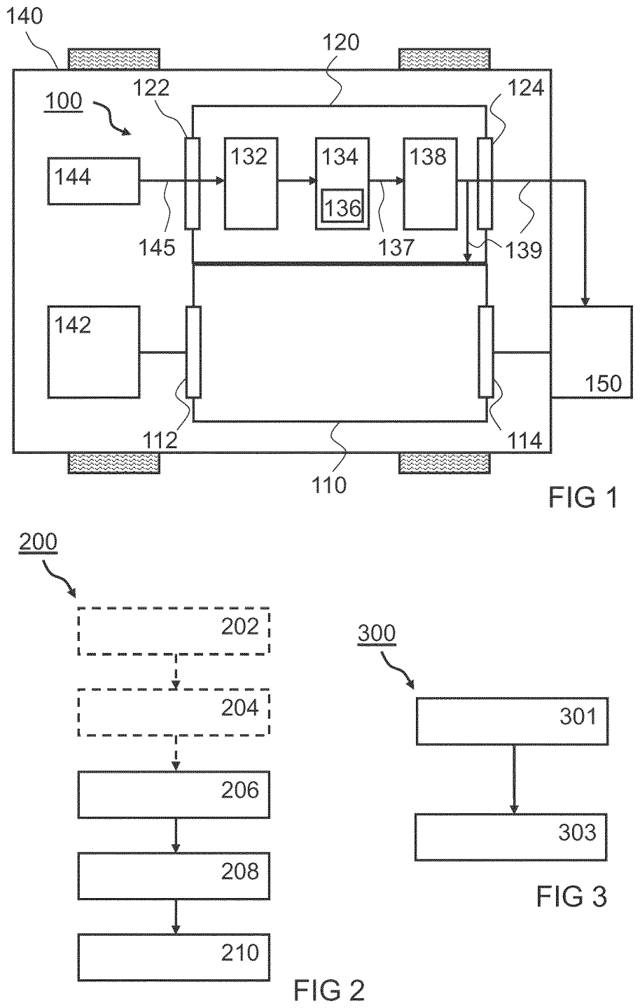

FIG. 1 shows a schematic depiction of an embodiment example of a device 100 for operating an electric auxiliary drive 150 for an electric vehicle 140. The electric vehicle 140 is constructed as a battery-operated vehicle, a hybrid vehicle, a vehicle using an internal combustion engine for driving the wheels and a battery as power supply for the auxiliary drive 150, a vehicle using an alternative propulsion, i.e., hydrogen, gas, etc., for driving the wheels and a battery as power supply for the auxiliary drive 150, or a vehicle using any combination of the above-mentioned types of power supplies for driving the wheels and for the auxiliary drive 150. In FIG. 1, the device 100 is arranged, by way of example, in the vehicle or electric vehicle 140. According to another aspect, the device 100 is constructed as part of the auxiliary drive 150.

The vehicle 140 comprises a vehicle battery 142 and a vehicle control device 144. Further, the vehicle 140 also comprises a main drive for driving at least one driven axle and, therefore, the wheels of the vehicle 140. According to the aspect shown here, the vehicle 140 also comprises the device 100. The electric auxiliary drive 150 is, for example, part of the vehicle 140 or is attached or attachable to the vehicle 140. The auxiliary drive 150 comprises an electric motor and/or a pump, for example.

The device 100 is formed to operate the electric auxiliary drive 150 for the electric vehicle 140. The device 100 comprises a bidirectional inverter 110 and a control arrangement 120. The bidirectional inverter 110 comprises a battery interface 112 and an auxiliary drive interface 114. The inverter 110 and, therefore, the device 100 are electrically connectable or, as is shown in FIG. 1, electrically connected to the vehicle battery 142 via the battery interface 112. The inverter 110 and, therefore, the device 100 are electrically connectable or, as is shown in FIG. 1, electrically connected to the auxiliary drive 150 via the auxiliary drive interface 114.

The control arrangement 120 comprises a first communications interface 122 and a second communications interface 124. The control arrangement 120 and, therefore, the device 100 are signal-transmissibly connectable or, as is shown in FIG. 1, signal-transmissibly connected to the electric vehicle 140, more exactly, for example, to the vehicle control device 144, via the first communications interface 122. The control arrangement 120 and, therefore, the device 100 are signal-transmissibly connectable or, as is shown in FIG. 1, signal-transmissibly connected to the auxiliary drive 150 via the second communications interface 124.

The control arrangement 120 also comprises an input unit 132, a determination unit 134, stored reference datasets 136 and a control unit 138. The input unit 132 is formed to input a configuration signal 145 via the first communications interface 122, optionally additionally or alternatively via the second communications interface 124. The configuration signal 145 is provided in response to an information request. The configuration signal 145 represents a present configuration of the electric vehicle 140 and/or of the auxiliary drive 150 or of an accessory application. The determination unit 134 is formed to determine with the use of the configuration signal 145 a set of control parameters 137 for the present configuration from the stored reference datasets 136 having control parameters associated with the respective configurations for different electric vehicles and different auxiliary drives. The control unit 138 is formed to control or actuate the inverter 110 using the set of control parameters 137 by a control signal 139.

According to an aspect, the control arrangement 120, more exactly the control unit 138, is also formed to control the auxiliary drive 150 using the set of control parameters 137 by the control signal 139 via the second communications interface 124. Optionally additionally, the control arrangement 120 is formed to detect a connection event representing a reconnection or first-time connection of an electric auxiliary drive 150 or of an electric vehicle 140 to the device 100 using the interfaces 112, 114, 122 and/or 124 of the device 100. Optionally additionally, the control arrangement 120 is formed to output, particularly to output to the vehicle control device 144, the information request for providing the configuration signal 145 via the first communications interface 122, optionally additionally or alternatively via the second communications interface 124, in response to a detected connection event. This is described in more detail in the following with reference to FIG. 5.

FIG. 2 shows a flow diagram of an embodiment example of a method 200 for operating an electric auxiliary drive for an electric vehicle. The method 200 for operating is executable by, or with the use of, the device from FIG. 1 or a similar device, more exactly the control arrangement of the device. The method 200 for operating comprises an input step 206, a determination step 208, and a control step 210.

In the input step 206, a configuration signal provided in response to an information request is inputted via a first communications interface to the electric vehicle and/or via a second communications interface to the auxiliary drive. The configuration signal represents a present configuration of the electric vehicle and/or of the auxiliary drive. The configuration relates to hardware and/or software. Subsequently, in the determination step 208 using the configuration signal, a set of control parameters for the present configuration is determined from a plurality of stored reference datasets with control parameters for different electric vehicles and different auxiliary drives, which control parameters are associated with respective configurations.

In the control step 210, a bidirectional inverter is controlled using the set of control parameters. The inverter comprises a battery interface for electrically connecting the inverter to a vehicle battery of the electric vehicle and an auxiliary drive interface for electrically connecting the inverter to the auxiliary drive. According to an aspect, in the control step 210 the auxiliary drive is controlled using the set of control parameters via the second communications interface.

According to an aspect, the method 200 for operating comprises a detection step 202 and, optionally additionally, an output step 204. In the detection step 202, a connection event representing a reconnection or first-time connection of an electric auxiliary drive or of an electric vehicle to the device is detected using the interfaces of the device. In the optionally additional output step 204, the information request for providing the configuration signal is outputted via the first communications interface and/or via the second communications interface in response to a detected connection event. According to an aspect, the input step 206 and the determination step 28 are carried out once after every detected connection event.

FIG. 3 shows a flow diagram of an aspect of a method 300 for providing reference datasets for a device for operating an electric auxiliary drive for an electric vehicle. By carrying out the method 300 for providing, reference datasets can be provided to be used by the device from FIG. 1 or a similar device and/or by the method for operating from FIG. 2 or a similar method. The method 300 for providing comprises an input step 301 and a storage step 303.

In the input step 301, configuration information representing various configurations and control parameters for different electric vehicles and different auxiliary drives associated with the respective configurations are inputted. Subsequently in the storage step 303, the configuration information and control parameters are stored in order to generate a plurality of reference datasets with control parameters associated with the respective configurations.

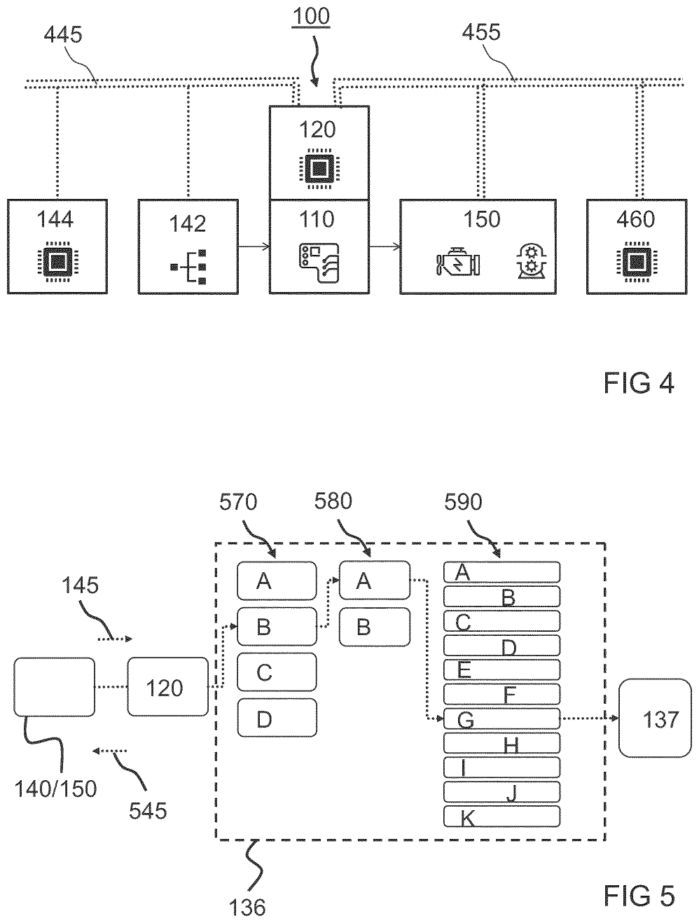

FIG. 4 shows a schematic view of an aspect of a device 100 for operating an electric auxiliary drive 150 for an electric vehicle. The device 100 corresponds to or resembles the device from FIG. 1. The inverter 110 of the device 100 is electrically connected to the vehicle battery 142 or to a power source or power distribution unit. Further, the inverter 110 is electrically connected to the auxiliary drive 150. The control arrangement 120 of the device 100 is signal-transmissibly connected to the vehicle battery 142 and the vehicle control device 144 via a CAN bus 455, hybrid CAN bus or the like. Further, the control arrangement 120 is signal-transmissibly connected to the auxiliary drive 150 and, for example, to an attachments control device 460 via an attachment CAN bus 455 or the like.

In particular, the vehicle control device 144 represents a main control device of the vehicle and/or a control device related to the vehicle. The vehicle battery 142 or a power supply/distribution represents a battery system, a communication being implemented through a battery management system. The device 100 for operating the electric auxiliary drive (ePTO) 150 represents a multifunctional bidirectional unit with a control arrangement (ECU=electronic control unit) which is formed to control the inverter and gather information from the system via a CAN line or the hybrid CAN bus 445. The device 100 also represents an ePTO interface. The electric auxiliary drive 150 or ePTO drive represents, for example, an electric motor controlled by the multifunctional inverter 110, and a pump which is connected directly to the electric motor. The attachments control device 460 represents the control device on the attachment side and/or the control device relating to the accessory application. The position of the multifunctional inverter or bidirectional inverter 110 is between the power distribution unit or vehicle battery 142, respectively, and the ePTO drive or auxiliary drive 150. An interface box used for additional functions could also be placed therebetween. This could be placed in the vehicle directly in the vehicle (in the factory) or in attachments (on the attachment side). A communication between control devices is also dependent thereon.

FIG. 5 shows a schematic representation of the function principle of the device from FIG. 1 and/or FIG. 4 with respect to a system configuration. As for the device, only the control arrangement 120 and particularly the reference datasets 136 and the set of control parameters 137 or software functions and system information are shown in FIG. 5. Further, the configuration signal 145, the information request 545 and a system communicating with the control arrangement 120 representing, for example, the vehicle 140 or the auxiliary drive 150 are shown. The reference datasets 136 are divided into groups in this case, for example, only three groups 570, 580 and 590, of individual reference datasets with associated control parameters in each instance.

Purely as example, a first group 570 of reference datasets represents different attachment suppliers A, B, C and D. A second group 580 of reference datasets represents, for example, different types of electric auxiliary drives A and B, for example, an asynchronous machine or a permanent magnet synchronous motor. A third group 590 of reference datasets represents, purely by way of example, different accessory applications A, B, C, D, E, F, G, H, I, J and K, for example, a milk truck, refrigerator truck, dry-running compressor, cement mixer or chemicals transporter, garbage truck, municipal vehicle, small dump truck or small flatbed, dump truck trailer or midsize dump truck, midsize breakbulk cargo crane, large breakbulk cargo crane or lumber car and concrete pump or midsize wheel loader.

An information request 545 reaches the system 140/150 from the ePTO control device or control arrangement 120. Because a handshake communication is programmed in particular, the control arrangement 120 receives the requested information embodied as the configuration signal 145. Referring to the concrete example of the reference datasets 136 or database with the latter which is shown here, the configuration signal 145 can represent the series of letters B-A-G, for example, with reference to the three groups 570, 580 and 590. After an evaluation, also using a software database, the control arrangement 120 recognizes the configuration, particularly the hardware in the system 140/150—for example, vehicle, type of ePTO, type of electric motor, in this case, for example, a particular attachment supplier, an asynchronous machine and a small dump truck or a small flatbed. Consequently, the correct software functions are used and, in addition, the specific signals are requested and/or received.

By way of summarizing and expressed in other words, a functional description with respect to embodiment examples is given in the following with reference to the figures described above. To prepare the plug-and-play function, a programming of the software or software database is carried out corresponding to or similar to method 300 from FIG. 3. The programming is carried out in accordance with the requirements, use conditions, application, etc. The communication with the vehicle 140 is considered, for example, as a KL15 or KL30 signal configuration. The software comprises a configuration of the communication via the CAN bus 445 and/or 455 and a database of specific information about the vehicle, if used. This concerns, for example, the attachments, the type of electric motor or the application. After preparing, the inverter 110 can be connected to the control arrangement 120 with any type of vehicle or application (insofar as it is contained in the database) and is ready to operate-no further steps need be carried out, drivers installed or equipment configured before the operational readiness is established. After connecting, the control arrangement 120 transmits an information request 545 via the CAN bus 445. Other control equipment 144 or other participants participating in the communication are also connected to the CAN bus 445 and these detect the newly connected control equipment, i.e., control arrangement 120, and its request. They then prepare the requested information embodied as configuration signal 145. Based on the received information, the control arrangement 120 evaluates it and detects the hardware being used in the system and also the software packages or software functions to be used in order to control particularly the electric motor of the auxiliary drive 150. A standardized interface for communication is also connected to the PnP functions. This is also advantageous because attachment suppliers and vehicle manufacturers can work with a standardized interface and need not adapt to each application. The communication is also standardized. A type of automated handling process between the participants is developed on the CAN line. This also saves time and costs because one software could be used in many applications.

The selected aspects described above and shown in the figures are exemplary only. Different aspects in their entirety, or only some features thereof, may be combined with one another. An embodiment example can also be modified by features of another embodiment example.

Further, method steps according to the invention may be repeated and carried out in a sequence other than that described herein.

When an embodiment example includes an “and/or” conjunction between a first feature and a second feature, this can be interpreted to mean that the embodiment example according to one embodiment form has both the first feature and the second feature and, according to a further embodiment form, either has only the first feature or has only the second feature.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A device for operating an electric auxiliary drive for an electric vehicle, comprising:
a bidirectional inverter having a battery interface configured to electrically connecting the bidirectional inverter to a vehicle battery of the electric vehicle;
an auxiliary drive interface configured to electrically connecting the bidirectional inverter to the auxiliary drive; and
a control arrangement having a first communications interface for signal transmission capable connection of the control arrangement to the electric vehicle and a second communications interface for signal transmission capable connection of the control arrangement to the auxiliary drive,
wherein the control arrangement is formed to input a configuration signal provided in response to an information request via the first communications interface and/or the second communications interface,
wherein the configuration signal represents a present configuration of the electric vehicle and/or of the auxiliary drive,
wherein the control arrangement is uses the configuration signal to determine a set of control parameters for the present configuration from a plurality of stored reference datasets with control parameters for different electric vehicles and different auxiliary drives, which control parameters are associated with respective configurations,
wherein the control arrangement is controls the inverter using the set of control parameters.

14. The device according to claim 13, wherein the control arrangement controls the auxiliary drive using the set of control parameters via the second communications interface.

15. The device according to claim 13, wherein the control arrangement is configured to detect a connection event using the interfaces of the device, wherein the connection event represents a reconnection or first-time connection of an electric auxiliary drive or of an electric vehicle to the device, wherein the control arrangement is formed to output the information request for providing the configuration signal via the first communications interface and/or via the second communications interface in response to a detected connection event.

16. An electric vehicle comprises:
a vehicle battery and
a bidirectional inverter having a battery interface configured to electrically connecting the bidirectional inverter to the vehicle battery of the electric vehicle;
an auxiliary drive interface configured to electrically connecting the bidirectional inverter to the auxiliary drive; and
a control arrangement having a first communications interface for signal transmission capable connection of the control arrangement to the electric vehicle and a second communications interface for signal transmission capable connection of the control arrangement to the auxiliary drive,
wherein the control arrangement is formed to input a configuration signal provided in response to an information request via the first communications interface and/or the second communications interface,
wherein the configuration signal represents a present configuration of the electric vehicle and/or of the auxiliary drive,
wherein the control arrangement is uses the configuration signal to determine a set of control parameters for the present configuration from a plurality of stored reference datasets with control parameters for different electric vehicles and different auxiliary drives, which control parameters are associated with respective configurations,
wherein the control arrangement is controls the inverter using the set of control parameters,
wherein the inverter is electrically connected to the vehicle battery via the battery interface and electrically connectable or electrically connected to the auxiliary drive via the auxiliary drive interface, wherein the control arrangement of device is signal-transmissibly connected to the electric vehicle via the first communications interface and is signal-transmissibly connectable or connected to the auxiliary drive via the second communications interface.

17. Electric auxiliary drive for an electric vehicle, comprising:
a device for operating an electric auxiliary drive for an electric vehicle, comprising:
a bidirectional inverter having a battery interface configured to electrically connecting the bidirectional inverter to a vehicle battery of the electric vehicle;
an auxiliary drive interface configured to electrically connecting the bidirectional inverter to the auxiliary drive; and
a control arrangement having a first communications interface for signal transmission capable connection of the control arrangement to the electric vehicle and a second communications interface for signal transmission capable connection of the control arrangement to the auxiliary drive,
wherein the control arrangement is formed to input a configuration signal provided in response to an information request via the first communications interface and/or the second communications interface,
wherein the configuration signal represents a present configuration of the electric vehicle and/or of the auxiliary drive,
wherein the control arrangement is uses the configuration signal to determine a set of control parameters for the present configuration from a plurality of stored reference datasets with control parameters for different electric vehicles and different auxiliary drives, which control parameters are associated with respective configurations,
wherein the control arrangement is controls the inverter using the set of control parameters,
wherein the inverter of the device is electrically connectable or electrically connected to the vehicle battery via the battery interface and electrically connected to the auxiliary drive via the auxiliary drive interface, wherein the control arrangement of the device is signal-transmissibly connectable or connected to the electric vehicle via the first communications interface and signal-transmissibly connected to the auxiliary drive via the second communications interface.

18. A method for operating an electric auxiliary drive for an electric vehicle, comprising:
inputting a configuration signal provided in response to an information request via a first communications interface to the electric vehicle and/or via a second communications interface to the auxiliary drive, wherein the configuration signal represents a present configuration of the electric vehicle and/or of the auxiliary drive;
determining with use of the configuration signal a set of control parameters for the present configuration from a plurality of stored reference datasets with control parameters for different electric vehicles and different auxiliary drives, which control parameters are associated with respective configurations; and
controlling a bidirectional inverter using the set of control parameters, wherein the inverter has a battery interface for electrically connecting the inverter to a vehicle battery of the electric vehicle and an auxiliary drive interface for electrically connecting the inverter to the auxiliary drive.

19. The method according to claim 18, wherein the auxiliary drive is controlled in the control step using the set of control parameters via the second communications interface.

20. The method according to claim 18, further comprising:
detecting a connection event using the interfaces of device,
wherein the connection event represents a reconnection or first-time connection of an electric auxiliary drive or of an electric vehicle to the device, and optionally additionally by a step for outputting the information request for providing the configuration signal via the first communications interface and/or via the second communications interface in response to a detected connection event.

21. The method according to claim 19, wherein the input step and the determination step are carried out once after every detected connection event.

22. A method for providing reference datasets for a device for operating an electric auxiliary drive for an electric vehicle, comprising:
inputting configuration information representing different configurations and control parameters for different electric vehicles and different auxiliary drives, which control parameters are associated with the respective configurations; and
storing the configuration information and control parameters in order to generate a plurality of reference datasets with control parameters associated with the respective configurations.

23. Machine-readable storage medium on which a computer program which is adapted to carry out and/or initiate a method, the method comprising:
inputting a configuration signal provided in response to an information request via a first communications interface to an electric vehicle and/or via a second communications interface to an auxiliary drive, wherein the configuration signal represents a present configuration of the electric vehicle and/or of the auxiliary drive;
determining with use of the configuration signal a set of control parameters for the present configuration from a plurality of stored reference datasets with control parameters for different electric vehicles and different auxiliary drives, which control parameters are associated with respective configurations; and
controlling a bidirectional inverter using the set of control parameters, wherein an inverter has a battery interface for electrically connecting the inverter to a vehicle battery of the electric vehicle and an auxiliary drive interface for electrically connecting the inverter to the auxiliary drive.
